(19) United States
(12) Patent Application Publication
(10) Pub. No.: US 2003/0101944 A1
(43) Pub. Date: Jun. 5, 2003

(54) Multi-purpose rescue, body support, anchor and tow strap

(76) Inventor: Stephen C. Heinrichs, Clayton, OH (US)

Correspondence Address: William Weigl, 1805 Conwood Dr., Troy, OH, 45373, US

(21) Appl. No.: 10/002,589

(22) Filed: Dec. 5, 2001

(51) Int. Cl. B60R 22/00

(52) U.S. Cl. 119/770

(57) ABSTRACT

A unitary multi-purpose elongated strap has at one end a pair of loops adapted for securement to a human body or inanimate object, and at the other end has at least one, and preferably two, loops for enabling control of the person or thing secured by the pair of loops. The strap has a large variety of uses, such as in the fields of rescue, personal rehabilitation, training, anchoring, towing, lifting and other uses as yet undiscovered. The design can be identical for all uses, although the strap lengths and proportions may vary for different uses.

This invention relates to a simple, inexpensive strap arrangement designed for partially or completely supporting or moving a human body or inanimate object for any of a variety of rehabilitation, training, rescue extrication, anchoring or towing purposes.

### BACKGROUND OF THE INVENTION

This invention had its genesis in my U.S. Pat. No. 5,540,188 entitled TODDLER HARNESS and U.S. Pat. No. 6,062,173 entitled UPPER BODY HARNESS SYSTEM, both of which patents are fully incorporated herein by reference. In the former patent, a small child's upper body is supported by a pair of loops while allowing the child to remain upright as he or she is learning to ride a bicycle. Its purpose is to teach bike riding without training wheels. An adult walks or jogs alongside the child being trained to allow the child to gain confidence in body balance until it is clear that partial strap support is no longer necessary. In the latter patent, somewhat similar belts or straps are used to similarly support a person's upper body during rehabilitation in relearning how to walk after a stroke or injury. The latter patent is primarily directed to an improvement that keeps the looped straps away from the sides of a person's face and directs them behind his or her head and neck when supported.

In the process of experimenting with the straps of my above patents, still other uses and other manners of using the straps for rescue, support and anchoring operations have also been found practical and desirable. A few examples of such uses are: 1) dragging a person by the wrists or feet from a burning fire, 2) lifting a human or animal from flood waters or some other dangerous situation, 3) mountain climbing, 4) anchoring an object in place or simply towing any heavy or cumbersome object from one location to another by hand or with a vehicle. The difficulty was in designing one type or kind of strap of flexible material that suits all of these presently-known uses, and to assure that the strap design was simple, inexpensive to produce, easy to use and attach and suitable for hand-carrying. Because different intended purposes entail use of different length straps, the design had to be one that could be readily produced in a variety of sizes while retaining commonality of features. In effect, it is desired that one type of strap suit all intended uses.

### SUMMARY OF THE INVENTION

A unitary multi-purpose elongated strap has at one end a pair of loops adapted for securement to a human body or inanimate object. At the other end the strap has at least one, and preferably two, loops for enabling control of the person or thing secured by the pair of loops. The strap has a large variety of uses, such as in the fields of rescue, personal rehabilitation, training, anchoring, towing and other uses as yet undiscovered. The design can be identical for all uses, although the strap lengths and proportions may vary for different uses.

It is a principal object of the invention to provide a unitary, multi-purpose strap having essentially the same design for a large variety of uses.

It is another object to produce the strap from relatively inexpensive flat flexible belting material with but a single point of securing the belting into its unitary form.

Another object is to provide that the strap be capable of conversion from an elongated form into a folded compact unit for ease of carrying in a person's pocket.

Another significant object is to provide that such strap be easily and inexpensively manufactured, and be produced in a form which makes for simplicity of use.

Other objects and advantages will become apparent from the following description, in which reference is made to the accompanying drawings.

### BRIEF DESCRIPTION OF THE DRAWINGS

FIG. 1 is a fragmentary view of one preferred form of strap lying in its flat extended or elongated form.

FIG. 2 is a plan view of the strap of FIG. 1 on a smaller scale, showing the loops of the strap spread slightly in a lateral direction as one would do in preparation for attachment purposes.

FIG. 3 is a view of the strap of FIG. 1 in a folded condition for ease of carrying in one's pocket, for example.

FIGS. 4-6 show simplified line views of a few of various alternative forms in which the strap of FIG. 1 may be produced.

FIG. 7 shows how a fireman can hitch one of the loops of the strap about a person's wrists or other body parts in a dragging or lifting rescue from a smoke-filled area.

FIG. 8 is a simplified depiction of the hitch applied in FIG. 8.

### DESCRIPTION OF THE PREFERRED EMBODIMENT

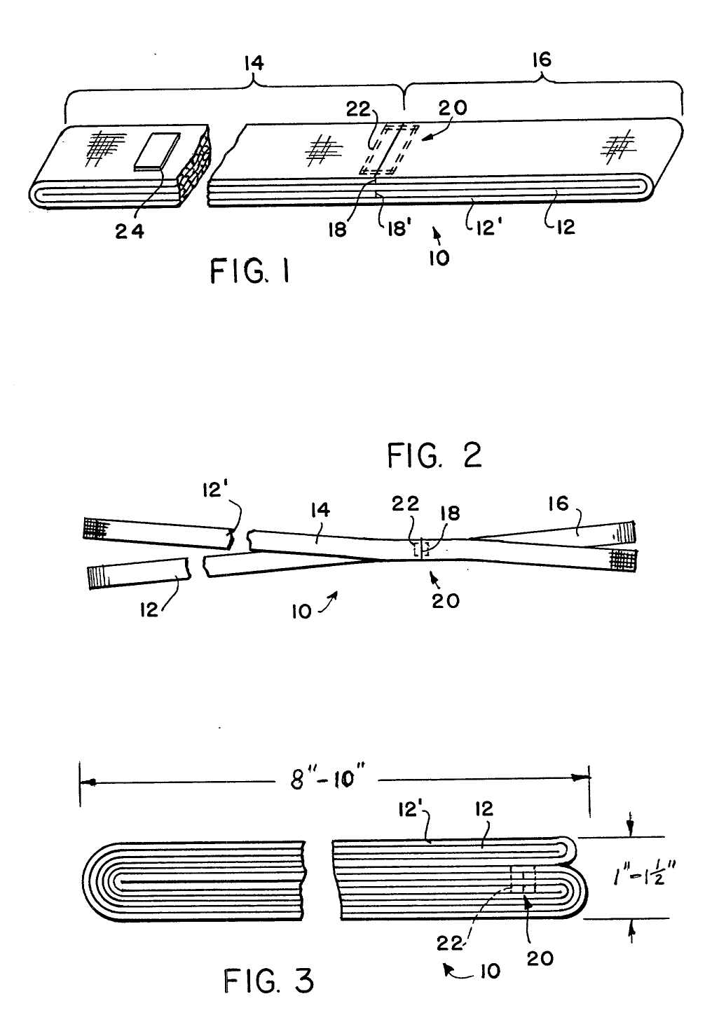

Although a strap 10 of my invention may be made of flexible belting which can be as little as 1/2 up to 3″ in width, I find it most suitable that its width be around 2″ and its thickness be 3/32 of an inch. The belting can be of any synthetic or natural material normally used for strong strapping, such as is commonly used in a large variety of products from seat belts to golf bag straps. In FIG. 1, I show the form of my strap preferred by firemen for rescue operations such as dragging an unconscious person by the wrists or feet along a floor from a burning fire, or hoisting a body or object from a confined space. This version of the strap 10 consists of a two-color unit for enabling a rescuer to easily distinguish two longer loops 14 at the left end of the strap 10 from each other during hitching of the longer loops 14 about each of a person's wrists as shown in FIG. 7. It can be seen that the FIGS. 1 and 2 version of strap 10 has an inner continuous belting 12 which may be red in color and an outer continuous belting 12′ which may be black in color, as shown by the color cross-hatching in FIG. 2. Each belting 12 and 12′ may be made from a length of belting material having its ends abutting each other at 18 and 18′ respectively. Where the terms “continuous” or “endless” are used herein in connection with the belting or loops, it should be understood that they are continuous after they are secured at a central area 20 by stitching 22 or other securing means. The term “central area” as used herein is intended to define the location between the distal ends of the strap 10 where the loops are interconnected. Obviously, the stitching will extend all the way through all of the belting layers lying adjacent one another, thus making each continuous element into two separate loops at opposite sides of the central area 20. The belting may be made continuous by any of several means such as overlapping and stitching, but I prefer to make the opposite ends of a single length of belting abut closely and then secure the belting 12 and 12′ together on opposite sides of the abutting ends 18 and 18′. Stitching is simple and effective, but other means of securing the belting at the central area 20 are also possible, including riveting, heat or glue bonding of certain materials, etc.

The total length of strap 10 of FIG. 1, when designed for fire rescue purposes, is preferably about twenty-five to thirty-three inches, with the longer loops 14 being eighteen to twenty-four inches in length and shorter loops 16 being approximately seven to nine inches in length. The proportions or ratios of the longer loops 14 to the shorter loops 16 for this particular use is on the order of 2:1 or 3:1, but obviously, can be any other desired ratio. Firemen prefer to use small straps 10 because they can be easily folded into the compact dimensions of perhaps 8″ or 10″ in length and 1″ to 1½″ in thickness, as shown in FIG. 3. This enables easy carrying in a pocket and requiring accessibility only if needed. Clearly, these dimensions can vary depending of what a particular fireman finds most suitable for his needs. Because of the strap's simplicity of construction, requiring only determining the lengths of the belting and the location of the stitching, it is easy for a manufacturer to tailor-make the end product for a particular fireman or crew.

For fire rescue or any other usage where the longer loops are desired to be distinguished in darkness, I may place one or more luminescent reflectors 24 on the outsides of the longer loops 14. Thus, if a fireman is going into a location where he cannot distinguish the different colors of the belting 12 and 12′, he can shine a flashlight on the reflector 24 prior to entering a dark area and then use the luminescence of the reflector to assist him in attaching the loops appropriately. The reflectors can be of any type of luminescent material that can be easily applied or attached to the belting, e.g., by means of pressure sensitive adhesive on the backs of the reflectors.

FIG. 2 illustrates a top view of a strap 10 lying flat on a surface as one about to attach the longer loops to a person or object would separate the loops 14 and 16 slightly laterally prior to selecting first one, then the other for attachment. If the wrists are to be secured for dragging or lifting a person, a hitch like that in FIG. 8 is formed in a longer loop 14 with one's fingers and slipped over one hand or other body part of the person to be rescued. After the same is done to the other wrist or body part, one rescuer can grab both loops 16 and begin the dragging or lifting, or two rescuers can each grab a loop 16 and commence towing together. The term “hitch” shall mean a knot formed by a secondary temporary double loop from an already-existing permanent single loop.

The strap 10 can take on a number of different configurations and construction, certain of which are best adapted to specific uses. For example, if used in the rehabilitation mode as described in my aforementioned U.S. Pat. No. 6,062,173, the length of the strap may be from about 36″ to 40″ and the ratio of longer loops to shorter loops may be on the order of 6:1.

Two-color belting is often preferred when using longer straps in a rehab situation to assist the person in attachment of one loop around one's back with one color and around the person's chest with the other colored loop. Since chest and back attachment is a bit more difficult than applying a hitch around a wrist, for example, some training is required and uses of different colored belting assists in developing an appropriate routine.

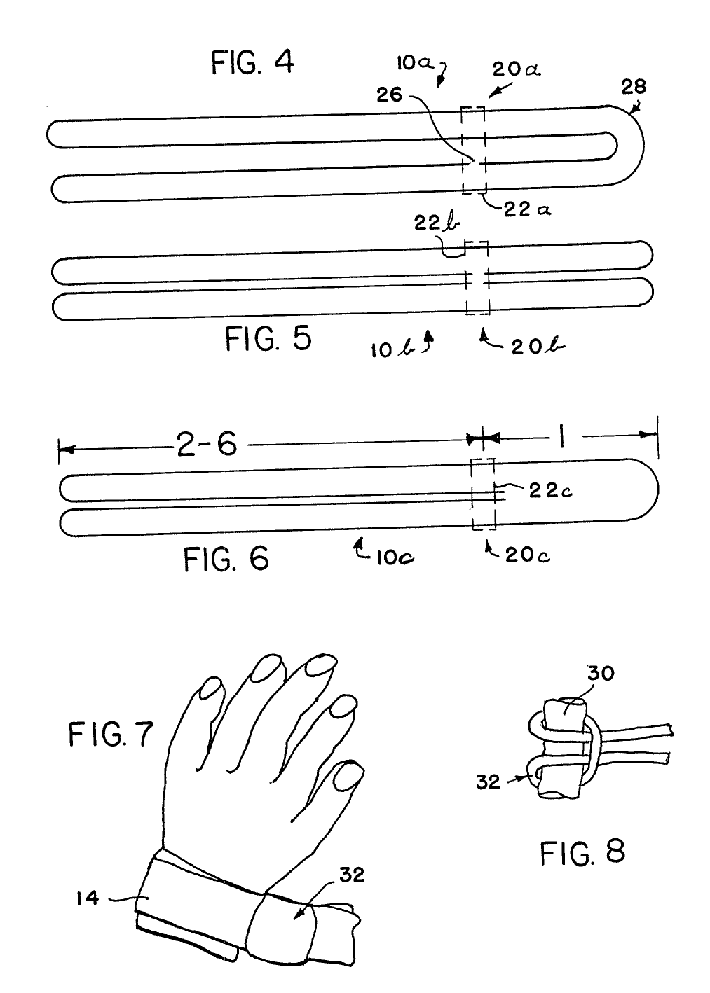

FIGS. 4-6 show a few of several alternative designs of belting construction that are possible. All incorporate the same general principle of usage by connecting two loops (usually the longer loops) to an individual or object, and using one or two opposing loops to tow, support or anchor the thing secured by the other loops.

In FIG. 4, the strap 10a is made of a single length of belting material with its ends being shown by the separation at abutting ends 26. Since of a single length, the belting of FIG. 4 must be of a single color. The ends at separation 26 are first brought into abutting relationship in a position where the central area 20a will later be created by stitching 22a while the belting is lying flat. The belting is then folded over at 28 to form the strap as shown. The stitching 22a is then created and the strap 10a is complete.

In FIG. 5, two continuous belting loops 12b and 12b′ of identical length are placed one atop the other with their abutting ends adjacent as shown. The stitching is then performed. This arrangement is suitable for belting that is to be of different colors.

In FIG. 6, I show a strap 10c which is made of one length of belting that is folded in half, and then the two ends are tucked inwardly and brought into the positions shown by the central area 20c. The ends are then stitched to the outer portions of the belting to form the strap 10c as shown in FIG. 6. It will be noted that this version of my invention has but a single loop 16c and a pair of loops 14c. While two shorter loops are preferred for strength as well as enabling towing by two persons, one loop 16c can do the job in many instances.

FIG. 7 shows a hitch about a person's wrist as described previously. In FIG. 8 the object 30 can be either a wrist, hand, leg or foot or can be a pipe, rail or other similar long item. The hitch 32 is shown as though it were a rope, for simplicity of illustration of the hitch of FIG. 7. If connected to a pipe or rail, the hitch is made differently than when it is created in one's fingers and looped over the end of a wrist, for example. To connect to a pipe, two loops are passed around the pipe and the other two loops are threaded through the first two loops. In effect, this creates a double hitch. It should be apparent that if rope were to be used instead of the belting described and claimed, it would tend to abrade or cut into the skin and flesh of a person's wrist. This would be particularly true if the person were quite heavy or were stuck in a small place and extreme tension had to be applied to the strap 10 to move the person. Obviously, there is always risk of injury to one's wrists in that situation, but if attempted with rope instead of the belting described above, the risk would be exacerbated.

In addition to the rescue and rehabilitation fields, my strap design is useful to hunters, where two hunters can drag a deer by its antlers or hooves, or one hunter can lift equipment such as a bow, rifle or food sack into a tree stand, etc. It can be used to anchor one thing to another, such as raising food in a sack out of reach of an animal. Also, with both sets of loops being made long enough, an adult can carry a child in front of himself by passing one set of loops about the child's chest and back as shown in my aforementioned '173 patent and insert his own arms into the other two loops and drape them either over his shoulders or around his neck. This enables his arms to be free for other purposes, if needed. Instead of chest support, two loops may be placed beneath a person's rump or knees and back, two others over the lifting person's shoulders and the lifter can use his hands and arms to aid in support or mobility. Although not yet used as such in practice, assuming the strength of the belting material is sufficient, it may also be useful for towing a vehicle. Additionally, two separate straps may be used as a pair in the form of a sling to support a person or object at spaced-apart locations from a single or a pair of points.

Various other changes and uses of the unique strap may be made without departing from the spirit and scope of the claims.

Having described my invention, I claim:

1. A unitary multi-purpose strap of flexible flat belting material having a plurality of loops extending outwardly from a central area of said strap at which all of said loops are firmly secured to each other by attaching means, a pair of first loops of essentially equal length extending outwardly in a first direction from said central area, and at least one second loop extending outwardly from said central area in a direction opposite to said pair of first loops.

2. A multi-purpose strap according to claim 1 wherein said at least one second loop comprises a pair of second loops of essentially equal length.

3. A multi-purpose strap according to claim 2 wherein the belting of all of said loops is of equal-width belting of between one-half and three inches.

4. A multi-purpose strap according to claim 2 wherein one first loop and one second loop comprises a first continuous strap, wherein the other first loop and the other second loop comprises a second continuous strap, and wherein said first and second continuous straps are of the same width and thickness dimensions and are interconnected at said central area by means of stitching.

5. A multi-purpose strap according to claim 4 wherein one of said continuous straps is of slightly smaller circumference than the other of said continuous straps and is nested inside the other of said continuous straps.

6. A multi-purpose strap according to claim 4 wherein said first and second loops are of different lengths when said strap is laid flat.

7. A multi-purpose strap according to claim 5 wherein said first continuous strap is of a color different than said second continuous strap.

8. A multi-purpose strap according to claim 2 wherein all of said loops are formed from a single continuous belt which is initially folded over onto itself at its midpoint into two elongated unconnected loops extending outwardly from said midpoint, and wherein said central area is formed by interconnecting said two elongated unconnected loops to create said pair of first loops and said pair of second loops.

9. A multi-purpose strap according to claim 8 wherein said first and second loops are of different lengths when said strap is laid flat.

10. A multi-purpose strap according to claim 1 wherein said multi-purpose strap comprises a length of flat belting which has been folded over at a midway point onto itself into two equal half-length sections, wherein both of said sections have been tucked inwardly and directed in equal amounts toward but not reaching said folded-over midway point, and wherein the inwardly tucked ends and adjacent portions of said belting have been stitched together to form said central area, said at least one second loop comprising a single loop extending between the central stitched area and said folded-over midway point.

11. A multi-purpose strap according to claim 10 wherein said first and second loops are of different lengths when said strap is laid flat.

12. A multi-purpose strap according to claim 1 wherein the ratio of lengths of said first and second loops is approximately between the order of 2:1 and 6:1.

13. A multi-purpose strap according to claim 12 wherein the ratio of lengths of said first and second loops is approximately 2:1.

14. A multi-purpose strap according to claim 12 wherein the ratio of lengths of said first and second loops is approximately 4:1.

15. A multi-purpose strap according to claim 1 wherein the ratio of lengths of said first and second loops is approximately 6:1.

16. A multi-purpose strap according to claim 13 wherein the total length of said strap between its ends is between twenty and thirty-six inches when said multi-purpose strap is extended in elongated form.

17. A multi-purpose strap according to claim 1 wherein the flexibility of said strap enables it to be folded into multiple thicknesses from an elongated form into a short compact unit for ease of carrying.

18. A multi-purpose strap according to claim 1 wherein said strap is formed from a pair of continuous belts of equal length, said belts lying adjacent one another and being joined at said central area, each of said belts comprising a first loop and a second loop on the same side of said strap.

19. A multi-purpose strap according to claim 1 wherein said flat belting material is on the order of two inches in width, and wherein said loops are formed into continuous straps by end-butting the lengths of belting material together and joining them at said central area.

20. A multi-purpose strap according to claim 19 wherein said joining is produced by stitching the ends of all of the belting material together on opposite sides of the end-butted lengths.
